(19) United States
(12) Patent Application Publication
(10) Pub. No.: US 2010/0097325 A1
(43) Pub. Date: Apr. 22, 2010

(54) TOUCH SCREEN ASSEMBLIES AND SADDLE-TYPE VEHICLES HAVING ONE OR MORE TOUCH SCREEN ASSEMBLIES

(76) Inventors: Daisuke Nagao, Long Beach, CA (US); Kenji Tamura, Redondo Beach, CA (US)

Correspondence Address: ULMER & BERNE, LLP;ATTN: DIANE BELL, 600 VINE STREET, SUITE 2800, CINCINNATI, OH, 45202, US

(21) Appl. No.: 12/254,935

(22) Filed: Oct. 21, 2008

(51) Int. Cl. G06F 3/041; B62K 11/00

(52) U.S. Cl. 345/173; 180/219

(57) ABSTRACT

A touch screen assembly is configured for attachment to a handlebar of a saddle-type vehicle. The touch screen assembly includes a display portion having a display screen and a touch sensor arrangement. The display screen is configured to display indicia relating to at least one electrical device present upon a saddle-type vehicle. At least one electrical device remote from the touch screen assembly is configured to be selectively controlled by an operator through use of the touch screen assembly. Saddle-type vehicles, such as motorcycles, may include a touch screen assembly.

### TECHNICAL FIELD

A touch screen assembly is provided for attachment to a handlebar of a saddle-type vehicle, such as a motorcycle.

### BACKGROUND

Conventional motorcycles are equipped with lever, toggle, and/or push-button actuators for use by an operator to activate a horn, turn signals, headlamps, and/or other functions of the motorcycle. However, these actuators are bulky, aesthetically unattractive, expensive, and are susceptible to mechanical damage resulting from inadvertent contact, moisture, and/or vibration damage. Additionally, as these actuators are typically dispersed across multiple locations on the motorcycle, an operator of the motorcycle must often remove his or her hand from a handlebar of the motorcycle to use at least some of these actuators.

### SUMMARY

In accordance with one embodiment, a saddle-type vehicle comprises a handlebar assembly, a touch screen assembly, and at least one electrical device. The handlebar assembly comprises a left handlebar and a right handlebar. The handlebar assembly is configured to facilitate steering of the saddle-type vehicle. The touch screen assembly is attached to one of the left handlebar and the right handlebar. The touch screen assembly comprises a display screen and a touch sensor arrangement. The electrical device is remote from the touch screen assembly and is configured to be selectively controlled by an operator through use of the touch screen assembly.

In accordance with another embodiment, a motorcycle comprises a handlebar assembly, a touch screen assembly, and at least one electrical device. The handlebar assembly comprises a left handlebar, a right handlebar, a left handgrip attached to the left handlebar, and a right handgrip attached to the right handlebar. The handlebar assembly is configured to facilitate steering of the motorcycle. The touch screen assembly is attached to one of the left handlebar and the right handlebar adjacent to one of the left handgrip and the right handgrip such that the touch screen assembly can be interfaced by an operator's hand without requiring removal of an operator's hands from the left handgrip and the right handgrip. The touch screen assembly has an external size and configuration similar to immediately adjacent portions of the handlebar assembly to which the touch screen assembly is attached. The touch screen assembly comprises a display screen and a touch sensor arrangement. The electrical device is remote from the touch screen assembly and is configured to be selectively controlled through use of the touch screen assembly. The electrical device comprises at least one of a turn signal, a headlamp, a horn, and an engine starter motor. The display screen is configured to display indicia relating to the electrical device. The touch sensor arrangement is configured to facilitate and detect an operator's selection of the indicia and to generate an electrical signal to facilitate control of said electrical device.

In accordance with yet another embodiment, a touch screen assembly is configured for attachment to a handlebar of a saddle-type vehicle. The touch screen assembly comprises a display screen and a touch sensor arrangement. The display screen is configured to display indicia relating to at least one electrical device present upon a saddle-type vehicle. The touch sensor arrangement is configured to facilitate and detect an operator's selection of the indicia and to generate an electrical signal to facilitate control of an electrical device remote from the touch screen assembly and corresponding with the indicia.

### BRIEF DESCRIPTION OF THE DRAWINGS

While the specification concludes with claims particularly pointing out and distinctly claiming the present invention, it is believed that the same will be better understood from the following description taken in conjunction with the accompanying drawings in which:

FIG. 1 is a side elevational view of a motorcycle having a touch screen assembly in accordance with one embodiment;

FIG. 2 is a rear view depicting an enlargement of a portion of the left handlebar of the motorcycle of FIG. 1;

FIG. 3 is a rear view depicting an enlargement of a portion of the right handlebar of the motorcycle of FIG. 1;

FIG. 4 is a perspective view depicting the portion of the right handlebar of FIG. 4; and

FIG. 5 is a schematic view depicting a portion of an electrical system as may be provided upon the motorcycle of FIG. 1.

### DETAILED DESCRIPTION

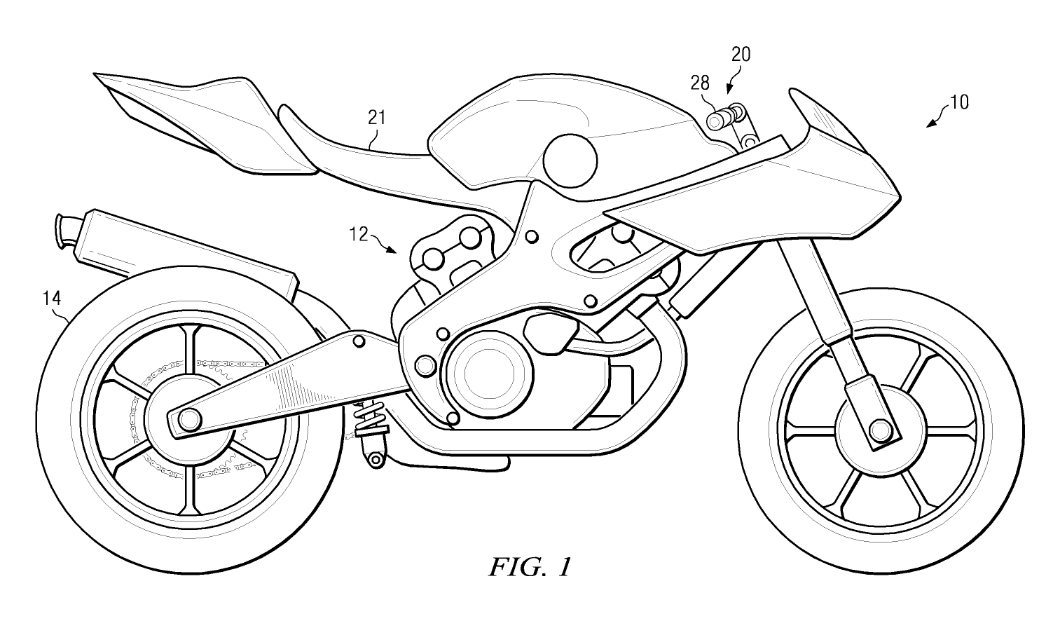

Embodiments are hereinafter described in detail in connection with the views and examples of FIGS. 1-5, wherein like numbers indicate the same or corresponding elements throughout the views. A touch screen assembly in accordance with one embodiment can be configured for attachment to a handlebar assembly of a saddle-type vehicle. A saddle-type vehicle can include, for example, any of a variety of vehicles configured for recreational or utility purposes and that comprises a handlebar to facilitate steering of the vehicle by an operator. For example, saddle-type vehicles can include motorcycles, scooters, all terrain vehicles, personal watercraft, and snowmobiles.

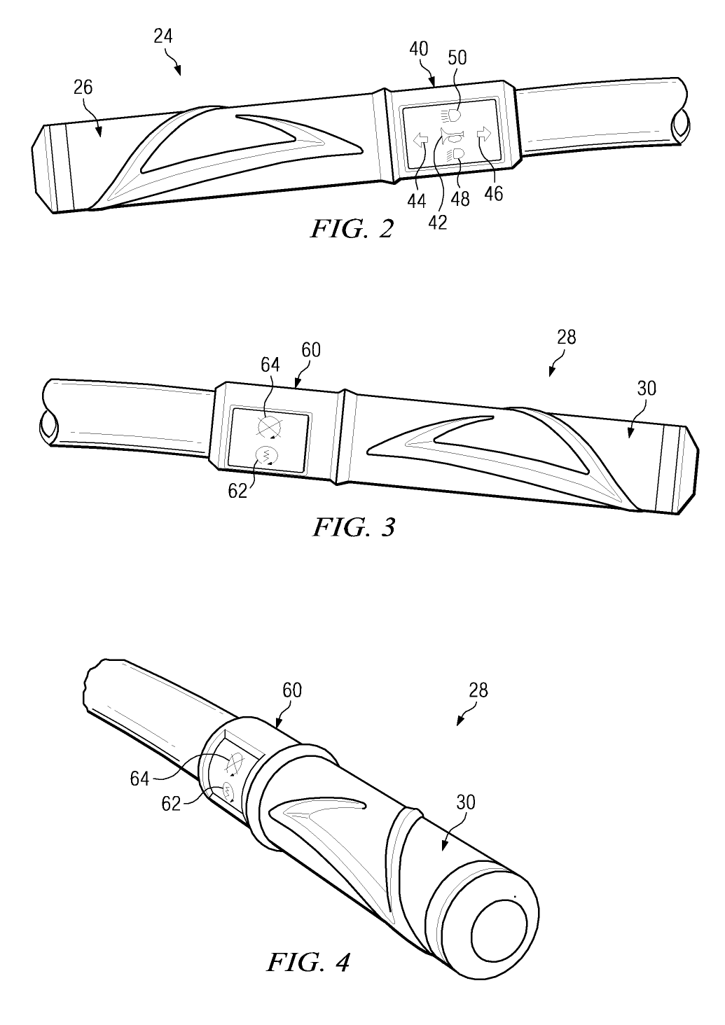

In one particular embodiment, as depicted in FIGS. 1-4, a motorcycle 10 is shown to include a handlebar assembly 20. The handlebar assembly 20 can be configured to facilitate steering of the motorcycle 10 by an operator of the motorcycle 10. The handlebar assembly 20 can include a left handlebar 24 and a right handlebar 28. The left handlebar 24 is shown in FIG. 2 to have a left handgrip 26, and the right handlebar 28 is shown in FIGS. 3-4 to have a right handgrip 30. An operator of the motorcycle 10 can, during operation of the motorcycle 10, selectively use his or her left hand to grasp the left handgrip 26 and/or his or her right hand to grasp the right handgrip 30.

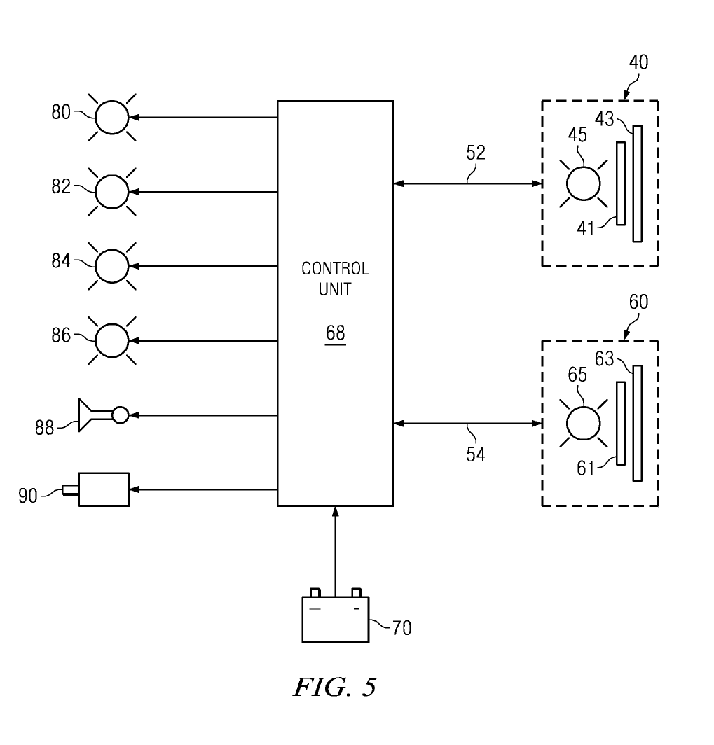

The motorcycle 10 can also comprise an engine 12 which is configured to generate power to facilitate movement of the motorcycle 10. Although the engine 12 is shown to comprise an internal combustion engine, the engine may alternatively comprise an electric motor and/or some other arrangement which is configured to facilitate rotation of the motorcycle's drive wheel(s) (e.g., rear wheel 14). In such circumstances where the engine 12 comprises an internal combustion engine, it will be appreciated that the engine can include a starter motor (e.g., 90 in FIG. 5) and can be configured to consume gasoline, diesel fuel, kerosene, natural gas, propane, alcohol, jet fuel, hydrogen, and/or any of a variety of other fuels. In certain alternative embodiments, the engine may comprise a series or parallel hybrid electric drive configuration which includes an electric motor and an internal combustion engine.

In one embodiment, one or more touch screen assemblies can be attached to the left and/or right handlebar(s) of a handlebar assembly of a saddle-type vehicle. For example, as depicted in FIG. 2, a left touch screen assembly 40 is shown to be attached to the left handlebar 24 of the handlebar assembly 20 at a location adjacent to the left handgrip 26. In this configuration, the left touch screen assembly 40 can be positioned to be operable by an operator's left hand without requiring removal of the operator's left hand from the left handgrip 26. As depicted in FIGS. 3-4, a right touch screen assembly 60 is shown to be attached to the right handlebar 28 of the handlebar assembly 20 at a location adjacent to the right handgrip 30. In this configuration, the right touch screen assembly 60 can be positioned to be operable by an operator's right hand without requiring removal of the operator's right hand from the right handgrip 30. Brake and/or clutch handles (not shown) might also be provided adjacent to one or both of the left and right handgrips 26, 30 such that they might be operable by an operator without requiring removal of the operator's hand from the adjacent handgrip.

In accordance with one embodiment, a touch screen assembly can have an external size and configuration similar to immediately adjacent portions of a handlebar assembly to which the touch screen assembly is attached. For example, as shown in FIGS. 2-4, the external configuration of each of the left and right touch screen assemblies 40 and 60 can be curved similarly to adjacent portions of the handlebar assembly (e.g., the left and right handgrips 26 and 30, respectively) and can have an outer diameter which is substantially the same as that of the adjacent portions of the handlebar assembly. In this configuration, the left and right touch screen assemblies 40 and 60 are shown to be configured as having the appearances of being integral with adjacent portions of the handlebar assembly 20. In particular, as shown in FIGS. 2-4, neither of the left and right touch screen assemblies 40 and 60 substantially protrude from the respective left and right handlebars 24 and. 28. As such, the left and right touch screen assemblies 40 and 60 do not add the appearance of bulk to the left and right handlebars 24 and 28. Also, the left and right touch screen assemblies 40 and 60 are not particularly susceptible to being damaged through contact with an operator and/or to injure an operator as a result of such contact.

A saddle-type vehicle in accordance with one embodiment can include one or more electrical devices which are remote from a touch screen assembly and which are configured to be selectively controlled by an operator through the use of the touch screen assembly. For example, such electrical devices can include, for example, an engine starter motor, an engine choke actuator, a fuel valve, a horn, turn signals, headlamps, running lamps, cargo lamps, gear shifting actuators, drive wheel selection actuators, radios, headsets, throttle actuators (e.g., as part of a cruise control system), and display screens. Headlamps can include low-beam headlamps, high-beam headlamps, fog headlamps, and driving headlamps, for example. Running lamps can be provided on the front, side and rear of a vehicle to make the vehicle's location and size apparent to drivers of other vehicles. Running lamps are often amber-colored when attached to a forward end of a vehicle and/or when forward-facing. Running lamps are often red-colored when attached to a rearward end of a vehicle and/or when rearward-facing. Running lamps are often white-colored when illuminating a license plate, for example, and can be provided in any of a variety of other colors. Any headlamps, running lamps, turn signals, and/or other lamps present upon a saddle-type vehicle can comprise LEDs, halogen bulbs, incandescent bulbs, high intensity discharge lamps, fluorescent lamps, neon lamps, and/or any other of a variety of alternative light sources.

Communication between each of the left and right touch screen assemblies 40 and 60 and other vehicle components, such as electrical devices, can occur via wires, fiber optics, and/or wirelessly, for example. In one particular embodiment, as shown in the schematic representation of FIG. 5, wires (e.g., 52 and 54) can be provided to connect each of the left and right touch screen assemblies 40 and 60 with a control unit 68 (e.g., an engine control unit or ECU) which is attached to the motorcycle 10 at a location remote from the handlebar assembly 20. The wires can be routed internally within each of the left and right handlebars 24 and 28 so that the wires are substantially concealed from contact and view by an operator or onlooker of the motorcycle 10. Alternatively, at least a portion of the wires can be attached to the exterior of the left and right handlebars 24 and 28 through use of straps and/or wire ties. The control unit 68 is also shown in FIG. 5 to be connected with a battery 70 which can be mounted upon the motorcycle 10 such as beneath an operator's seat (e.g., 21 in FIG. 1). The control unit 68 is additionally shown in FIG. 5 to be connected with electrical devices comprising the left turn signal 80, the right turn signal 82, a low-beam headlamp 84, a high-beam headlamp 86, a horn 88, and a starter motor 90, all of which can be provided upon the motorcycle 10. It will be appreciated that the control unit 68 may be connected with any of a variety of additional and/or alternative electrical devices and/or other components of the motorcycle 10.

A touch screen assembly in accordance with one embodiment can include a display screen and a touch sensor arrangement. For example, as shown in FIG. 5, the left touch screen 40 is shown to include a display screen 41 and a touch sensor arrangement 43, and the right touch screen 60 is shown to include a display screen 61 and a touch sensor arrangement 63. A display screen in accordance with one embodiment (e.g., 41, 61) can be configured to display indicia relating to at least one electrical device present upon a saddle-type vehicle. A touch sensor arrangement (e.g., 43, 63) in accordance with one embodiment can be configured to facilitate and detect an operator's selection of the indicia and to generate an electrical signal to facilitate control of an electrical device remote from the touch screen assembly and corresponding with the indicia. A display screen and a touch sensor arrangement can be provided in any of a variety of alternative configurations. For example, in one embodiment, as shown in FIG. 5, each of the display screens 41 and 61 can comprise an LED, LCD, TFT, vacuum-fluorescent or other panel-type display, and each of the touch sensor arrangements 43 and 63 can comprise an overlay associated with the display screen. The overlay can involve one or more layers of material which move relative to one another and/or have varying properties when the touch screen assembly is contacted by an operator, thereby resulting in contact between layers and/or some other measurable electrical change (e.g., variation in resistance, capacitance, or inductance) of the layer(s) when the touch screen assembly is touched by an operator.

A touch screen assembly in accordance with one embodiment might include a backlight disposed behind the display screen and the touch sensor arrangement. The backlight can be configured to enhance an operator's visibility of the touch screen assembly during nighttime driving, and/or to indicate actuation of a particular electrical device. For example, as shown in FIG. 5, the left touch screen assembly 40 can include a backlight 45 and the right touch screen assembly 60 can include a backlight 65.

As shown in FIGS. 3 and 5, the left touch screen assembly 40 can include a first portion 42, a second portion 44, a third portion 46, a fourth portion 48, and a fifth portion 50. It will be appreciated that portions of each of the display screen 41 and the touch sensor arrangement 43 of the left touch screen 40 can correspond with each of the portions 42, 44, 46, 48, and 50. In one embodiment, with reference to FIGS. 2 and 5, the first portion 42 can relate to the horn 88, the second portion 44 can relate to the left turn signal 80, the third portion 46 can relate to the right turn signal 82, the fourth portion 48 can relate to the low-beam headlamp 84, and the fifth portion 50 can relate to the high-beam headlamp 86.

As shown in FIGS. 3-5, the right touch screen assembly 60 can include a first portion 62 and a second portion 64. It will be appreciated that portions of each of the display screen 61 and the touch sensor arrangement 63 of the right touch screen 60 can correspond with each of the first and second portions 62 and 64. In one embodiment, as shown in FIGS. 3-4, the first portion 62 can relate to the starter motor 90 and the second portion 64 can relate to an engine stop circuit. It will be appreciated that one or more touch screen assemblies provided upon a saddle-type vehicle can be configured to include indicia relating to any of a variety of additional and/or alternative electrical devices provided upon a saddle-type vehicle.

The portion of the display screen 41 corresponding with the first portion 42 of the left touch screen assembly 40 is shown in FIG. 2 to include a horn symbol. When an operator desires to activate the horn 88, he or she need simply touch the first portion 42 of the left touch screen assembly 40. When an operator touches the first portion 42, the portion of the touch sensor arrangement 43 corresponding with the first portion 42 detects the touch and generates an electrical signal to facilitate control of the horn 88. In one embodiment, the horn symbol may be illuminated (or perhaps more prominently illuminated) or otherwise visually distinguished such as by the display screen 41 and/or the backlight 45 to indicate to an operator of the motorcycle 10 that the left touch screen assembly 40 has registered the operator's touch.

The portion of the display screen 41 corresponding with the second portion 44 of the left touch screen assembly 40 is shown in FIG. 2 to include a left arrow symbol. When an operator desires to activate the left turn signal 80, he or she can touch the second portion 44 of the left touch screen assembly 40. When an operator touches the second portion 44, the portion of the touch sensor arrangement 43 corresponding with the second portion 44 detects the touch and generates an electrical signal to facilitate control of the left turn signal 80. In one embodiment, the left arrow symbol may be illuminated (or perhaps more prominently illuminated) or otherwise visually distinguished such as by the display screen 41 and/or the backlight 45 to indicate to an operator of the motorcycle 10 that the left touch screen assembly 40 has registered the operator's touch and/or that the left turn signal 80 is illuminated.

The portion of the display screen 41 corresponding with the third portion 46 of the left touch screen assembly 40 is shown in FIG. 2 to include a right arrow symbol. When an operator desires to activate the right turn signal 82, he or she can touch the third portion 46 of the left touch screen assembly 40. When an operator touches the third portion 46, the portion of the touch sensor arrangement 43 corresponding with the third portion 46 detects the touch and generates an electrical signal to facilitate control of the right turn signal 82. In one embodiment, the right arrow symbol may be illuminated (or perhaps more prominently illuminated) or otherwise visually distinguished such as by the display screen 41 and/or the backlight 45 to indicate to an operator of the motorcycle 10 that the left touch screen assembly 40 has registered the operator's touch and/or that the right turn signal 82 is illuminated.

The portion of the display screen 41 corresponding with the fourth portion 48 of the left touch screen assembly 40 is shown in FIG. 2 to include a low-beam headlamp symbol. When an operator desires to activate the low-beam headlamp 84, he or she can touch the fourth portion 48 of the left,touch screen assembly 40. When an operator touches the fourth portion 48, the portion of the touch sensor arrangement 43 corresponding with the fourth portion 48 detects the touch and generates an electrical signal to facilitate control of the low-beam headlamp 84. In one embodiment, the low-beam headlamp symbol may be illuminated (or perhaps more prominently illuminated) or otherwise visually distinguished such as by the display screen 41 and/or the backlight 45 to indicate to an operator of the motorcycle 10 that the left touch screen assembly 40 has registered the operator's touch and/or that the low-beam headlamp 84 is illuminated.

The portion of the display screen 41 corresponding with the fifth portion 50 of the left touch screen assembly 40 is shown in FIG. 2 to include a high-beam headlamp symbol. When an operator desires to activate the high-beam headlamp 86, he or she can touch the fifth portion 50 of the left touch screen assembly 40. When an operator touches the fifth portion 50, the portion of the touch sensor arrangement 43 corresponding with the filth portion 50 detects the touch and generates an electrical signal to facilitate control of the high-beam headlamp 86. In one embodiment, the high-beam headlamp symbol may be illuminated (or perhaps more prominently illuminated) or otherwise visually distinguished such as by the display screen 41 and/or the backlight 45 to indicate to an operator of the motorcycle 10 that the left touch screen assembly 40 has registered the operator's touch and/or that the high-beam headlamp 86 is illuminated.

The portion of the display screen 61 corresponding with the first portion 62 of the right touch screen assembly 60 is shown in FIGS. 3-4 to include a starter motor symbol. When an operator desires to start the engine 12, he or she can touch the first portion 62 of the right touch screen assembly 60. When an operator touches the first portion 62, the portion of the touch sensor arrangement 63 corresponding with the first portion 62 detects the touch and generates an electrical signal to facilitate control of the starter motor 90. In one embodiment, the starter motor symbol may be illuminated (or perhaps more prominently illuminated) or otherwise visually distinguished such as by the display screen 61 and/or the backlight 65 to indicate to an operator of the motorcycle 10 that the right touch screen assembly 60 has registered the operator's touch.

The portion of the display screen 61 corresponding with the first portion 62 of the right touch screen assembly 60 is shown in FIGS. 3-4 to include a stop symbol. When an operator desires to stop the engine 12, he or she can touch the second portion 64 of the right touch screen assembly 60. When an operator touches the second portion 64, the portion of the touch sensor arrangement 63 corresponding with the second portion 64 detects the touch and generates an electrical signal to cause rotation of the engine 12 to cease (e.g., to disable spark plug firing and/or fuel injection). In one embodiment, the stop symbol may be illuminated (or perhaps more prominently illuminated) or otherwise visually distinguished such as by the display screen 61 and/or the backlight 65 to indicate to an operator of the motorcycle 10 that the right touch screen assembly 60 has registered the operator's touch.

Through use of the left touch screen assembly 40, it will thus be appreciated that an operator of the motorcycle 10 can control each of the left turn signal 80, the right turn signal 82, the low-beam headlamp 84, the high-beam headlamp 86, and the horn 88, all through use of the operator's left hand (e.g., the left thumb), and without requiring the operator's left hand to be removed from the left handgrip 26. Likewise, through use of the right touch screen assembly 60, an operator of the motorcycle 10 can start and stop the engine 12 through use of the operator's right hand (e.g., the right thumb), and without requiring the operator's right hand to be removed from the right handgrip 30. It will also be appreciated that a touch screen assembly in accordance with an alternative embodiment might be configured to include additional and/or alternative indicia for use in controlling one or more additional and/or alternative electrical devices present upon a motorcycle or other vehicle. While the handlebar assembly 20 of the motorcycle 10 is depicted in FIGS. 2-4 to include two touch screen assemblies (i.e., 40 and 60) associated with respective handlebars (i.e., 24 and 28), it will be appreciated that a saddle-type vehicle in accordance with an alternative embodiment might only include a single touch screen (e.g., associated with either a left handlebar or a right handlebar). However, by attaching respective touch screen assemblies to respective handlebars of a saddle-type vehicle, fewer indicia can be provided upon a single touch screen assembly, and there can accordingly be a reduced likelihood that an operator will inadvertently contact the wrong portion of a touch screen assembly, and thus inadvertently activate an inappropriate electrical device during operation of the motorcycle.

A touch screen assembly in accordance with one embodiment can also include one or more information indicia. Information indicia can be configured to provide information to an operator, but electrical signals might not be generated in response to an operator's touching of a portion of the touch sensor arrangement corresponding with the information indicia. For example, information indicia can relate to engine information or status, gear information or status, drive wheel selection information or status, radio information or status, headset information or status, cruise control information or status, speed information or status, warning information or status, fuel level information or status, and/or oil level information or status.

In one embodiment, the arrangement, selection, and/or display of indicia on a touch screen assembly can be selectively manipulated by an operator of the saddle-type vehicle. For example, the touch screen assembly can include a menu through which different groups of indicia can be selected for display by an operator. The menu can include a graphical user interface system and/or a context menu system which provides indicia according to the current working condition of the saddle-type vehicle. In one embodiment, a touch screen assembly can be configured such that the symbolic representation for any given indicia can be selected by an operator. Also, the arrangement of indicia on a touch screen assembly might be selectable by an operator.

Significant benefits can be achieved by attaching a touch screen assembly to a handlebar of a saddle-type vehicle. For example, a touch screen assembly in accordance with one embodiment (e.g., as shown in FIGS. 2-4) can be configured to include no movable parts such that damage to the touch screen assembly during use of the saddle-type vehicle (e.g., resulting from contact, moisture, and/or vibration) is unlikely. As another example, a touch screen assembly in accordance with another embodiment (e.g., as shown in FIGS. 2-4) can consolidate multiple controls into a single location, thereby simplifying an operator's control of the saddle-type vehicle. Additionally, a touch screen assembly in accordance with yet another embodiment (e.g., as shown in FIGS. 2-4) can provide a sleek appearance, thereby providing aesthetic benefits and reduced bulk upon a handlebar of a saddle-type vehicle.

The foregoing description of embodiments and examples of the invention has been presented for purposes of illustration and description. It is not intended to be exhaustive or to limit the invention to the forms described. Numerous modifications are possible in light of the above teachings. Some of those modifications have been discussed and others will be understood by those skilled in the art. The embodiments were chosen and described in order to best illustrate the principles of the invention and various embodiments as are suited to the particular use contemplated. The scope of the invention is, of course, not limited to the examples or embodiments set forth herein, but can be employed in any number of applications and equivalent devices by those of ordinary skill in the art. Rather it is hereby intended that the scope of the invention be defined by the claims appended hereto.

What is claimed is:

1. A saddle-type vehicle comprising:
a handlebar assembly comprising a left handlebar and a right handlebar, wherein the handlebar assembly is configured to facilitate steering of the saddle-type vehicle;
a touch screen assembly attached to one of the left handlebar and the right handlebar, wherein the touch screen assembly comprises a display screen and a touch sensor arrangement; and
at least one electrical device remote from the touch screen assembly and configured to be selectively controlled by an operator through use of the touch screen assembly.

2. The saddle-type vehicle of claim 1 wherein the display screen is configured to display indicia relating to said electrical device, and the touch sensor arrangement is configured to facilitate and detect an operator's selection of the indicia and to generate an electrical signal to facilitate control of said electrical device.

3. The saddle-type vehicle of claim 1 wherein said electrical device comprises at least one of a turn signal, a headlamp, a horn, and an engine starter motor.

4. The saddle-type vehicle of claim 1 wherein the touch screen assembly has an external size and configuration similar to immediately adjacent portions of the handlebar assembly to which the touch screen assembly is attached.

5. The saddle-type vehicle of claim 4 wherein the touch screen assembly is configured to have the appearance of being integral with the handlebar assembly.

6. The saddle-type vehicle of claim 1 wherein the handlebar assembly further comprises a left handgrip and a right handgrip, the left handgrip is attached to the left handlebar, the right handgrip is attached to the right handlebar, and the touch screen assembly is attached to the handlebar assembly at a location adjacent to one of the left handgrip and the right handgrip such that the indicia on the touch screen assembly can be selected by an operator's hand without requiring removal of an operator's hands from the left handgrip and the right handgrip.

7. The saddle-type vehicle of claim 1 wherein the touch screen assembly further comprises a backlight.

8. The saddle-type vehicle of claim 1 comprising a motorcycle.

9. The saddle-type vehicle of claim 1 further comprising a second touch screen assembly attached to the other one of the left handlebar and the right handlebar.

10. A motorcycle comprising:
a handlebar assembly comprising a left handlebar, a right handlebar, a left handgrip attached to the left handlebar, and a right handgrip attached to the right handlebar, wherein the handlebar assembly is configured to facilitate steering of the motorcycle;
a touch screen assembly attached to one of the left handlebar and the right handlebar adjacent to one of the left handgrip and the right handgrip such that the touch screen assembly can be interfaced by an operator's hand without requiring removal of an operator's hands from the left handgrip and the right handgrip, wherein the touch screen assembly has an external size and configuration similar to immediately adjacent portions of the handlebar assembly to which the touch screen assembly is attached, the touch screen assembly comprises a display screen and a touch sensor arrangement; and
at least one electrical device remote from the touch screen assembly and configured to be selectively controlled through use of the touch screen assembly, wherein said electrical device comprises at least one of a turn signal, a headlamp, a horn, and an engine starter motor;
wherein the display screen is configured to display indicia relating to said electrical device, and the touch sensor arrangement is configured to facilitate and detect an operator's selection of the indicia and to generate an electrical signal to facilitate control of said electrical device.

11. The motorcycle of claim 10 further comprising a second touch screen assembly attached to the other one of the left handlebar and the right handlebar adjacent to the other one of the left handgrip and the right handgrip.

12. A touch screen assembly configured for attachment to a handlebar of a saddle-type vehicle, the touch screen assembly comprising:
a display screen configured to display indicia relating to at least one electrical device present upon a saddle-type vehicle; and
a touch sensor arrangement configured to facilitate and detect an operator's selection of the indicia and to generate an electrical signal to facilitate control of an electrical device remote from the touch screen assembly and corresponding with the indicia.

13. The touch screen assembly of claim 12 wherein the indicia relates to at least one of a turn signal, a headlamp, a horn, and an engine starter motor.

14. The touch screen assembly of claim 12 wherein the touch screen assembly has an external size and configuration similar to immediately adjacent portions of a handlebar to which the touch screen assembly is configured for attachment.

15. The touch screen assembly of claim 12 wherein the touch screen assembly is configured to have the appearance of being integral with a handlebar to which the touch screen assembly is attached.

16. The touch screen assembly of claim 12 further comprising a backlight.

17. The touch screen assembly of claim 12 wherein the touch sensor arrangement comprises an overlay adjacent to the display screen.
